(19) United States
(12) Patent Application Publication
(10) Pub. No.: US 2004/0079275 A1
(43) Pub. Date: Apr. 29, 2004

(54) Wallet whistle

(76) Inventor: Gregory Alan Falla, New Britain, CT (US)

Correspondence Address: Gregory Alan Falla, 1813 Stanley Street, New Britain, CT, 06053, US

(21) Appl. No.: 10/413,105

(22) Filed: Apr. 14, 2003

Related U.S. Application Data
(60) Provisional application No. 60/420,450, filed on Oct. 24, 2002.

(51) Int. Cl. F21S 10/00

(52) U.S. Cl. 116/202

(57) ABSTRACT

A mouth whistle that is comprised of a plastic card with substantially the same dimensions as a standard credit card, a fold, and registered air inlets that are substantially aligned when the card is folded. The Wallet Whistle can be unfolded for convenient storage. It can be printed with attractive logos, pictures, and/or designs. The card is made of a flexible material that can be repeatedly bent without fracturing along an axis substantially bisecting the plane of said card. The axis of the card may contain a previous fold, crease, score, openings, or a flexible membrane, any of which acts as a hinge to facilitate folding.

### CROSS-REFERENCE TO RELATED APPLICATIONS

This application claims the benefit of Provisional Patent Application serial No. 60/420,450, filed on Oct. 23, 2002.

### FEDERALLY SPONSORED RESEARCH

Not Applicable

### SEQUENCE LISTING OR PROGRAM

### Not Applicable

### BACKGROUND OF INVENTION—FIELD OF INVENTION

This invention relates to a folding mouth whistle that can be folded and unfolded by hand to allow for storage in a person's wallet, purse, or pocket like a credit card.

### BACKGROUND OF THE INVENTION—PRIOR ART

Mouth whistles have been used for some time. They are used for musical purposes and for signally as in animal training and control. These whistles are required to be inserted in the user's mouth. All previous inventions have been bulky and expensive in comparison to the Wallet Whistle. The object of my improvement involves a folding design to allow for convenient storage. In addition, this invention is easier and less expensive to manufacture.

U.S. Pat. No. 733,122, issued Jul. 7, 1903 describes a musical mouth whistle with a front horn section. The whistle is designed to be placed inside the user's mouth with laterally extended apertures to prevent ejection. The horn section and the lateral apertures contribute to a rigid and bulky design.

U.S. Pat. No. 805,817, issued Nov. 28, 1905 describes a musical mouth whistle. This whistle has ridges to keep the whistle in the user's mouth and a front horn assembly. The design and construction of this whistle provides rigid and bulky product.

British patent 241,974 was granted on Nov. 5, 1925. This whistle consists of a circular blank folded onto itself with a centrally located hole on the upper and lower walls. This whistle is placed inside the user's mouth and is held in place by hand. Although this whistle is less bulky than previous patents, it is still bulky in comparison to the Wallet Whistle and does not include a folding feature.

Australian patent 136,866 was granted on Apr. 3, 1950. This patent describes another mouth whistle with features to provide tonal qualities. This whistle is also required to be inserted inside the user's mouth. The design to provide tonal qualities contributes to the whistle's bulky design.

U.S. Pat. No. 5,201,276 dated Apr. 13, 1993 describes a somewhat flattened hemi-orbate mouth whistle with elliptical cavity provided with groves designed to keep the whistle in the user's mouth. This whistle is very similar to the earlier whistles with more comfortable construction. Nonetheless, it is still very bulky compared to the Wallet Whistle.

None of the previous mouth whistles can compare to the Wallet Whistle in regard to its convenient, compact, and affordable design. Not one of the previous mouth whistles includes the feature that allows for folding and unfolding for convenient storage like the Wallet Whistle. All previous mouth whistles are more expensive and far less compact then the Wallet Whistle. These whistles are rigid and bulky. All previous whistles require a more intense and costly manufacturing process than the Wallet Whistle and none incorporate a folding design.

### BACKGROUND OF THE INVENTION—OBJECTS AND ADVANTAGES

Some objects and advantages of the Wallet Whistle are:

a) Because of its folding design, this whistle is highly compact. It can be carried in a wallet, purse, pocketbook, key-chain, or anywhere else you could carry a regular credit card or key card.

b) This whistle is highly convenient. Because of its compact design, it can be taken anywhere, anytime. It can even be used can be used as a security alert device

c) This whistle is highly affordable. Because the type of material used and the simplicity of the design, the Wallet Whistle is a much less expensive whistle then previous mouth whistles. It can sell for a fraction of the cost of current mouth whistles. It can even be used as a promotional product.

d) This whistle is very attractive. Designs and logos can be printed on the whistle to provide a very visually attractive product.

### SUMMARY

This invention relates to a folding mouth whistle. The Wallet Whistle is a novel whistle capable of a very loud whistle. The Wallet Whistle can be made from a standard credit card size plastic card. Perhaps the most attractive feature of the Wallet Whistle is its ability to be folded and unfolded. This feature allows for convenient storage. When unfolded it can be carried or stored like a credit card. When folded, the whistle is comprised of an upper and a lower plate. The surfaces of the upper and lower plates are separated and contain holes that are substantially aligned above and below each other.

Because of its folding design, this whistle is highly compact and convenient and can easily be carried in one's wallet. It is lightweight and durable. It is convenient to use as well. This whistle is ideal for sport fans and entertainment enthusiasts. Logos and designs can be printed on the surfaces of the whistle. It is very attractive in appearance and can be very effectively used as a promotional product.

### DRAWINGS—FIGURES

FIG. 1 shows the Type 1 Wallet Whistle in plan view before folding.

FIG. 2 shows the Type 1 Wallet Whistle's edge view before folding.

FIG. 3 shows the Type 1 Wallet Whistle in isometric view after folding. The fold runs along the length of the whistle. The holes in the two planes are aligned after the fold.

FIG. 4 shows the Type 2 Wallet Whistle in plan view before folding.

FIG. 5 shows the Type 2 Wallet Whistle's edge view before folding.

FIG. 6 shows the Type 2 Wallet Whistle in isometric view after folding. The fold runs across the width of the whistle. The holes in the two planes are aligned after the fold.

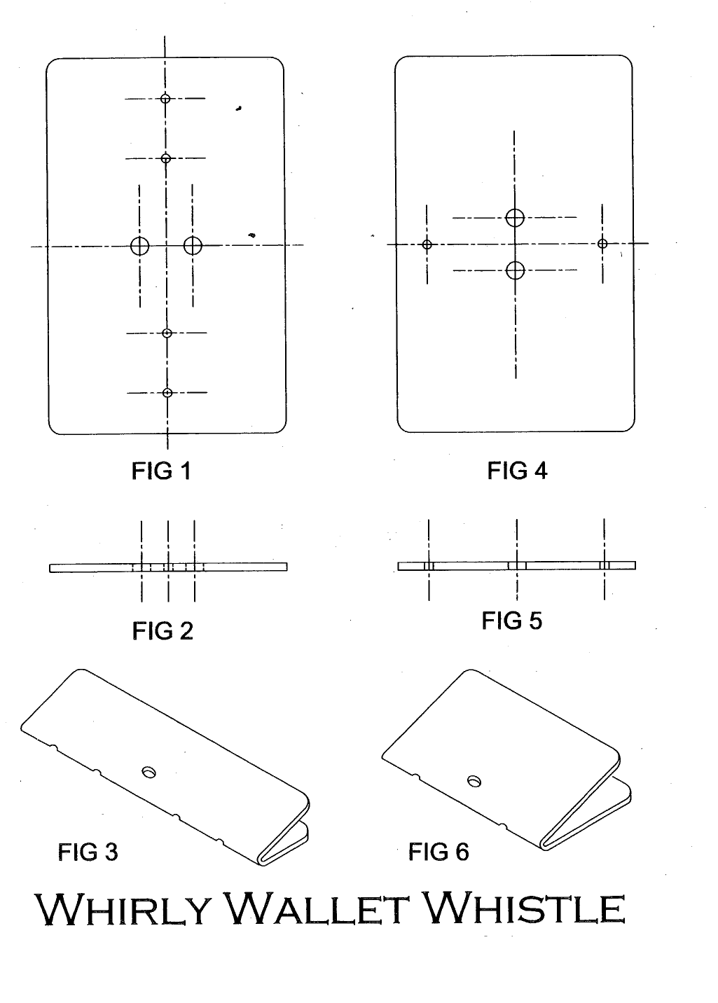

### DETAILED DESCRIPTION—PREFERRED EMBODIMENT—FIGS. 1-3

The preferred embodiment of the Wallet Whistle is illustrated on FIG. 1 (top view, unfolded), FIG. 2 (end view, unfolded), and FIG. 3 (isometric view after folding). The Wallet Whistle is primarily rectangular in shape as shown in the drawings. It contains two air holes near the center of the card. These holes are positioned on an axis parallel to one of the edges. They are separated substantially on center. A set of openings is provided perpendicular to said axis containing the air holes. This acts as hinge to allow the whistle to be easily folded. After folding, the whistle is comprised of an upper and lower plate and the air holes are substantially aligned. Type 1 is comprised of a longitudinal fold (FIGS. 1,2, and 3). The fold can be assisted by means other than a set of substantially small holes. It can be comprised of a set of slots, a groove, a perforation, a previous fold, a score, or even a hinge connecting two otherwise completely separate plates.

The fold is the portion that is placed in the user's mouth. The upper and lower walls of the whistle are pierced with substantially aligned holes adjacent to the fold. The holes should be positioned so as to allow the user to whistle without placing a substantial part of the whistle in his/her mouth. The material used should be material that can be repeatedly bent without fracturing such as polyvinyl chloride, polyethylene, polypropylene, vinyl, nylon, rubber, leather, various impregnated or laminated fibrous materials, various plasticized materials, etc. The four corners are typically rounded or beveled to avoid snagging or scratching. The angle of the fold can be adjusted to allow for different tonal qualities and user techniques.

Operation—FIGS. 1-3

To use the Wallet Whistle it must first be folded substantially in half along the smaller holes. After folding, the two larger holes on the upper and lower plates should be substantially aligned. The user places the folded edge of the whistle in his/her mouth so the larger holes are past the lips. The tongue must be placed on the folded edge of the whistle. Along with the proper placement, the proper blowing technique is required. The whistle can be unfolded and stored in a wallet, purse, pocketbook, or anywhere else you store a credit card.

### DETAILED DESCRIPTION—ADDITIONAL EMBODIMENT—FIGS. 4-6

An addition embodiment of the Wallet Whistle is illustrated on FIG. 4 (top view, unfolded), FIG. 5 (end view, unfolded), and FIG. 6 (isometric view after folding). The Wallet Whistle is primarily rectangular in shape as shown in the drawings. It contains two air holes near the center of the card. These holes are positioned on an axis parallel to one of the edges. They are separated by substantially on center. A set of openings is provided perpendicular to said axis containing the air holes. This acts as hinge to allow the whistle to be easily folded. After folding, the whistle is comprised of an upper and lower plate and the air holes are substantially aligned. Type 1 is comprised of a longitudinal fold (FIGS. 4, 5, and 6). The fold can be assisted by means other than a set of substantially small holes. It can be comprised of a set of slots, a groove, a perforation, a previous fold, a score, or even a hinge connecting two otherwise completely separate plates.

The fold is the portion that is placed in the user's mouth. The upper and lower walls of the whistle are pierced with substantially aligned holes adjacent to the fold. The holes should be positioned so as to allow the user to whistle without placing a substantial part of the whistle in his/her mouth. The material used should be material that can be repeatedly bent without fracturing such as polyvinyl chloride, polyethylene, polypropylene, vinyl, nylon, rubber, leather, various impregnated or laminated fibrous materials, various plasticized materials, etc. The four corners are typically rounded or beveled to avoid snagging or scratching. The angle of the fold can be adjusted to allow for different tonal qualities and user techniques. The front of the whistle can be held in place with a catch such as a tab and slot (or similar technique) when assembled.

Operation—FIGS. 4-6

To use the Wallet Whistle it must first be folded substantially in half along the smaller holes. After folding, the two larger holes on the upper and lower plates should be substantially aligned. The user places the folded edge of the whistle in his/her mouth so the larger holes are past the lips. The tongue must be placed on the folded edge of the whistle. Along with the proper placement, the proper blowing technique is required. The whistle can be unfolded and stored in a wallet, purse, pocketbook, or anywhere else you store a credit card.

### CONCLUSIONS, RAMIFICATIONS, AND SCOPE

Accordingly, the reader will see that the Wallet Whistle can be used to support their favorite team or individual. It can be produced with relatively little expense. The Wallet Whistle is ideal as a promotional item. Schools, organizations, or business can have names, designs, and/or pictures printed on the card. The Wallet Whistle can be given to students, employees, members, clients, and/or customers.

Although the description above contains many specifications, these should not be construed as limiting the scope of the invention but merely as providing illustrations of some of the presently preferred embodiments of this invention. For example, the whistle can have other shapes, such as circular, oval, elliptical, triangular, etc., the holes may be comprised of shapes other than circular, or the fold can be replaced by a hinge, perforations, or straps.

Thus the scope of the invention should be determined by the appended claims and their legal equivalents, rather than by the examples given.

### ADVANTAGES

The advantages of the Wallet Whistle over previous mouth whistles are clear.

1. Because of its folding design, it can be stored and carried like a credit card. Its lightweight flat design allows the Wallet Whistle can be taken anywhere at anytime.

2. It is inexpensive. The design is concise and simple. This makes the Wallet Whistle inexpensive to create and very affordable.

3. It is durable. The plastic material can withstand moisture, moderate hot and cold temperatures, and pressure.

4. The design is sleek and attractive. Unlike earlier mouth whistles, the Wallet Whistle is non-bulky and colorful. The whistle can be printed with virtually any design.

What I claim as my invention is:

1. A mouth whistle comprised of two plates with substantially separated surfaces created by a fold of a blank whereby each plate contains registering air-inlet openings substantially aligned when said blank is folded.

2. The mouth whistle of claim 1 wherein said upper and lower plates are comprised of semi circles, ovals, polygons, or some other geometric shape.

3. The mouth whistle of claim 1 wherein said blank is comprised of polyvinyl chloride or other substantially non-absorbent material.

4. The mouth whistle of claim 1 wherein the line of said fold is assisted by a set of substantially small openings.

5. The mouth whistle of claim 1 wherein said fold is created by the breaking of the blank along a score or indentation with a membrane acting as a hinge between the two pieces created by said break.

6. The mouth whistle of claim 1 wherein said fold is determined by a hinge connecting two separate plates.

7. The mouth whistle of claim 1 wherein said blank can be manually unfolded.

8. A process comprised of two air-inlet openings located on and substantially aligned between separated plates which are created by folding a blank whereby said openings produce a whistling sound with an introduction of forced air when said openings are substantially aligned.

9. The process in claim 8 wherein said upper and lower plates are comprised of semi circles, ovals, polygons, or some other geometric shape.

10. The process in claim 8 wherein said blank is comprised of polyvinyl chloride or other substantially non-absorbent material.

11. The process in claim 8 wherein the line of said fold is assisted by a set of substantially small openings.

12. The process in claim 8 wherein said fold is created by the breaking of the blank along a score or indentation with a membrane acting as a hinge between the two pieces created by said break.

13. The process in claim 8 wherein said fold is determined by a hinge connecting two separate plates.

14. The mouth whistle of claim 8 wherein said blank can be manually unfolded.

15. A mouth whistle comprised of a predetermined fold along an axis to establish substantially parallel plates wherein said plates are comprised of registered air inlet openings substantially aligned when said axis is folded and a single plane when said blank is unfolded.

16. The mouth whistle of claim 15 wherein said upper and lower plates are comprised of semi circles, ovals, polygons, or some other geometric shape.

17. The mouth whistle of claim 15 wherein said blank is comprised of polyvinyl chloride or other substantially non-absorbent material.

18. The mouth whistle of claim 15 wherein said line of the fold is assisted by a set of substantially small openings.

19. The mouth whistle of claim 15 wherein said fold is created by the breaking of the blank along a score or indentation with a membrane acting as a hinge between the two pieces created by said break.

20. The mouth whistle of claim 15 wherein said fold is determined by a hinge connecting two separate plates.
